(19) United States
(12) Patent Application Publication
(10) Pub. No.: US 2024/0010366 A1
(43) Pub. Date: Jan. 11, 2024

(54) Systems, assemblies and methods for payload testing

(71) Applicant: Gravitilab Aerospace Services Limited, Northamptonshire (GB)

(72) Inventors: Rob Adlard, Northamptonshire (GB); Callium Rolfe, Northamptonshire (GB); Aaron McNeil, Northamptonshire (GB)

(21) Appl. No.: 18/349,368

(22) Filed: Jul. 10, 2023

(30) Foreign Application Priority Data
Jul. 8, 2022 (GB) 2210042.4

(51) Int. Cl. B64G 7/00; G01M 99/00; B64G 1/66

(52) U.S. Cl. CPC B64G 7/00; G01M 99/00; B64G 1/66

(57) ABSTRACT

Vehicles systems, assemblies and methods for payload testing are described. A vehicle assembly, for example a suborbital vehicle assembly, has a housing for accommodating a test payload therein, and a payload exposure system coupled to the housing, operable to: open an aperture in the housing to allow exposure of a housed test payload to an in-flight environment; and close the aperture. The payload exposure system may have an actuator, which may have a drive system, for opening and closing the aperture. The actuator may be a linear actuator, whose operative action may be in an axial direction of the vehicle assembly.

### FIELD OF THE INVENTION

This invention is directed to systems, assemblies and methods for payload testing, in particular for payload testing for spacecraft, for example suborbital spacecraft.

### BACKGROUND OF THE INVENTION

Testing of payloads and components intended for spacecraft is increasing in importance in applications for orbital, outer space and planetary science, exploration and commercialisation. Such testing typically aims to simulate one or more of the environmental and movement conditions experienced by payloads during launch, flight, orbit, spaceflight, re-entry to an atmosphere and landing/recovery.

For example, environmental conditions during suborbital, orbital and spaceflight can include extremes of temperature, radiation exposure, exposure to the vacuum of space, and the like. Payloads may experience micro-gravity conditions (for example, in orbital environments), or lower-than-Earth gravity conditions, such as may be experienced on the lunar surface or on the surface of planetary bodies. During launch and other manoeuvres, the payload may experience extreme g-forces and vibration, for example. Simulated conditions or environments can be used to test components or devices, or to perform experiments in those conditions, without having to use the environment itself, for example by incurring the expense of putting the component or experiment itself in orbit or full spaceflight.

Systems for payload or component testing are known to the art. Terrestrial based systems for exposing payloads to environmental conditions can attempt to simulate temperature differences, radiation exposure or generate vacuum exposure. These systems may not be able to fully or accurately simulate a spaceflight environment, or may not be able to achieve such conditions at the same time or in the same test. Systems are available for attempting micro-gravity simulation, though many are inadequate for full micro-gravity testing, for sufficient time periods, let alone in combination with any simulated environmental conditions. Many payload testing systems do not include the capability to fully recover the intact test item.

Payloads may also be tested on orbit, for example on an orbital spacecraft, or on an orbital platform such as the International Space Station. However, the costs for such testing are prohibitive for all but the very most valuable spacecraft and science programmes, and are typically not available to common commercial endeavours.

In addition, known payload testing or deployment systems can be cumbersome, limited by the operating mechanics of the spacecraft and/or fairing, and often do not efficiently use the capacity available to the spacecraft. Further, electronics systems for known payload systems can be inefficient in, for example, power supply and data acquisition. Testing and deployment systems for aircraft are known to the art, but these are incapable of sub-orbital or orbital trajectories; for example, such systems would likely malfunction at sub-orbital flight speeds or in sub-orbital space environments.

The present invention aims to address these problems and provide improvements upon the known devices and methods.

### STATEMENT OF INVENTION

Aspects and embodiments of the invention are set out in the accompanying claims.

In general terms, one embodiment of an aspect of the invention can provide a suborbital vehicle assembly for payload testing, comprising: a housing for accommodating a test payload therein; and a payload exposure system coupled to the housing, operable to: during flight, open an aperture in the housing to allow exposure of a housed test payload to an in-flight environment; and close the aperture.

This assembly, for example including a (re)closable aperture on a suborbital test craft, allows a means for providing exposure to all facets of a space environment.

Optionally, the payload exposure system comprises an actuator for opening and closing the aperture. In embodiments, the actuator comprises a driver or drive means. Suitably, the actuator is a linear actuator, and the linear actuator is operable in an axial direction of the vehicle assembly.

In embodiments, the assembly comprises a first vehicle section, a second vehicle section, and the payload exposure system comprises an intermediary structure coupled between the first and second sections.

Optionally, in a closed configuration the first and second vehicle sections are coupled together; and the payload exposure system is operable in the closed configuration to separate the first and second vehicle sections to establish the aperture between the first and second vehicle sections in an open configuration. Suitably, the payload exposure system is operable to return the first and second vehicle sections from the open configuration to the closed configuration. The payload exposure system may be operable to extend the second vehicle section from the first vehicle section.

Suitably, the assembly comprises one or more sealing elements between the first and second vehicle sections. The assembly may comprise a seat between the first and second vehicle sections. Opposing portions of the seat disposed on the first and second vehicle sections may cooperate to seat the first vehicle section on the second vehicle section. In an embodiment where the housing is generally cylindrical, the seal and/or seat means may be generally annular.

Suitably, the intermediary structure comprises a modular payload support.

Optionally, the payload exposure system is operable to, for example during a rotational manoeuvre of the vehicle, permit egress of a housed payload via the aperture, for deployment.

One embodiment of another aspect of the invention can provide a spacecraft vehicle assembly, comprising: a housing for accommodating a payload therein, the housing comprising a body and a fairing, the body and fairing being separably coupled to one another; and an actuatable system for axially extending the fairing away from the body to establish an opening between the fairing and the body, the actuatable system comprising means for removably securing one or more payload items.

Optionally, the system is operable to retract the fairing back to the body to close the opening.

One embodiment of another aspect of the invention can provide a spacecraft vehicle assembly, comprising: a housing for accommodating a payload therein; and a payload deployment system coupled to the housing, operable to: open an aperture in the housing; and, during a rotational manoeuvre of the vehicle, permit egress of a housed payload via the aperture for deployment. The housing may be configured to prevent deployment or enclose the payload during a or the manoueuvre. The payload system may be operable to allow the payload out of the aperture by removing a centripetal force. The removing may be opening the aperture.

In embodiments, a housed payload may be coupled to a deployment device of the payload deployment system, which device being biased to prevent movement of the payload in an inward radial direction, and to permit movement of the payload in an outward radial direction. The deployment device may be a roller device.

One embodiment of another aspect of the invention can provide a vehicle assembly for payload testing, comprising: a housing for accommodating a payload therein; and a payload exposure system, operable to: open an aperture in the housing to allow exposure of a housed payload to an in-flight environment.

One embodiment of another aspect of the invention can provide a spacecraft vehicle assembly, comprising: a housing for accommodating a payload therein, the housing comprising a body and a fairing, the body and fairing being separably coupled to one another; and an actuatable system for extending the fairing away from the body to establish an opening or aperture.

One embodiment of another aspect of the invention can provide a method for testing payload of a suborbital vehicle, comprising: operating a payload exposure system of a suborbital vehicle during a flight of the vehicle to: open an aperture in a housing of the vehicle, to allow exposure of a housed test payload to an in-flight environment; and close the aperture.

Suitably, the method comprises operating the payload exposure system in an axial direction of the vehicle. This allows opening the aperture in the axial direction.

In an embodiment, wherein in a closed configuration first and second vehicle sections are coupled together, the method comprises operating the payload exposure system in the closed configuration to separate the first and second vehicle sections to establish the aperture between the first and second vehicle sections in an open configuration. The method may comprise operating the payload exposure system to return the first and second vehicle sections from the open configuration to the closed configuration.

Suitably, the method comprises operating the payload exposure system to, during a rotational manoeuvre of the vehicle, permit egress of a housed payload via the aperture, for deployment.

One embodiment of another aspect of the invention can provide a method for testing payload of a suborbital vehicle, comprising: initiating a flight of a suborbital vehicle, the vehicle comprising a housing and a payload exposure system; operating the payload exposure system of the vehicle during a flight of the vehicle to: open an aperture in the housing of the vehicle, to allow exposure of a housed test payload to an in-flight environment; retain the test payload in the housing; and close the aperture.

One embodiment of another aspect of the invention can provide a method of operating a spacecraft vehicle assembly, the assembly comprising a housing for accommodating a payload therein, the housing comprising a body and a fairing, the body and fairing being separably coupled to one another, the method comprising: axially extending the fairing away from the body to establish an opening between the fairing and the body; and removably securing one or more payload items in the housing. The method may comprise retracting the fairing back to the body to close the opening.

One embodiment of another aspect of the invention can provide a method of operating a spacecraft vehicle assembly, the assembly comprising a housing for accommodating a payload therein and a payload deployment system coupled to the housing, the method comprising: opening an aperture in the housing; and, during a rotational manoeuvre of the vehicle, permitting egress of a housed payload via the aperture for deployment.

The above aspects and embodiments may be combined to provide further aspects and embodiments of the invention.

### BRIEF DESCRIPTION OF THE DRAWINGS

The invention will now be described by way of example with reference to the accompanying drawings, in which:

FIGS. 1a, 1b, 2a and 2b are diagrams illustrating features of a vehicle assembly according to an embodiment of the invention;

FIG. 2c is a diagram illustrating steps of a method according to an embodiment of the invention;

FIG. 3 is a diagram illustrating components of a system in a deployed arrangement according to an embodiment of the invention; and

FIG. 4 is a diagram illustrating components of a system in a deployed arrangement with accommodated payloads according to an embodiment of the invention.

### DETAILED DESCRIPTION OF EMBODIMENTS

Embodiments of the invention allow efficient systems and methods for in-space, in-flight or in-orbit environmental testing of payload items in a spacecraft, by providing a means for opening (and closing) an aperture in the sub-orbital- or space-craft; a payload housed inside the craft can therefore be exposed to the environmental conditions in the high atmosphere, in orbit or in outer space (for example). The aperture is closable, so that the payload can be re-sealed inside the spacecraft for recovery, for instance by re-entry into the Earth's atmosphere and landing. These systems and methods can provide cost profiles for payload testing orders of magnitude lower than previous systems and methods requiring orbital or major spacecraft flight.

For the avoidance of doubt the meaning of “sub-orbital” used herein is its normal or commonplace meaning of a vehicle not reaching orbit or orbital velocity, having a trajectory achieving less than one orbit of the earth (or body), usually applied to a spacecraft. It is noted that the meaning is not a literal separate interpretation of “sub-” meaning less than, and “orbital”, thus implying any trajectory of any object at all that is not orbital, such as for example a coin toss.

An in-flight environment may include any conditions potentially experienced by the payload on an orbital or sub-orbital flight (or high atmosphere flight), which the payload would not expect to experience in a normal terrestrial environment, and/or which may be difficult or expensive to reproduce on Earth, such as extremes of temperature, radiation exposure, exposure to the vacuum of space, micro-gravity conditions or lower-than-Earth gravity conditions.

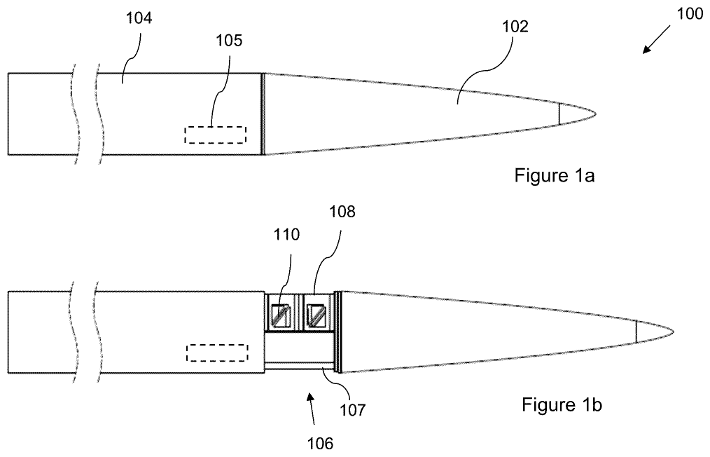

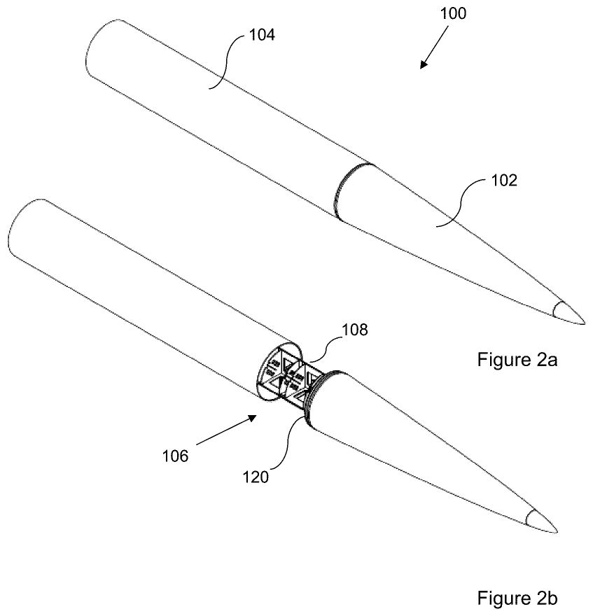

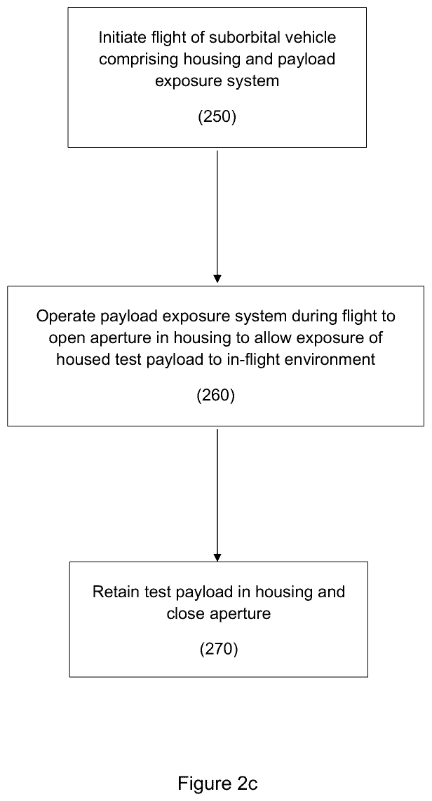

FIGS. 1a, 1b, 2a and 2b illustrate a vehicle assembly (100) according to an embodiment of the invention; FIG. 2c illustrates steps of a method according to an embodiment of the invention. The vehicle has a housing, in this example made up of multiple sections. The housing in this case is of a spacecraft, although in embodiments the vehicle assembly may be a suborbital vehicle assembly, a suborbital space (or space capable, or spaceflight) vehicle assembly and/or may only be capable of reaching the high atmosphere. In this example, the housing for the payload or payload items or components forms generally the outer surface of the vehicle—in other embodiments the vehicle launched or deployed may contain other housing components, or other sections or stages. In the example shown, the vehicle includes or is operable with an engine system, booster or other means (not shown) for launching or propelling the vehicle—for instance, the vehicle may be (or be a stage of) a rocket or similar craft launched from the Earth's or a planetary body surface.

In embodiments the vehicle is a sub-orbital vehicle; this allows the vehicle to reach heights above the atmosphere (over 100 km, for example) in order to provide exposure to the environmental conditions of space (such as lower earth orbit (LEO)), whilst not requiring the vehicle, assembly or payload to be capable of entering orbit. In other embodiments, the vehicle may be an orbital vehicle, or the assembly may be a suborbital sub-section of a non-space vehicle, or alternatively of an orbital vehicle.

In this embodiment, the housing is divided into an upper nose section (102) generally conically shaped, and a cylindrical body section (104); the division point (106) is a generally annular central region of the assembly. These shapes or dimensions are of course typical of rocket craft; other similar shapes and dimensions are envisaged in embodiments.

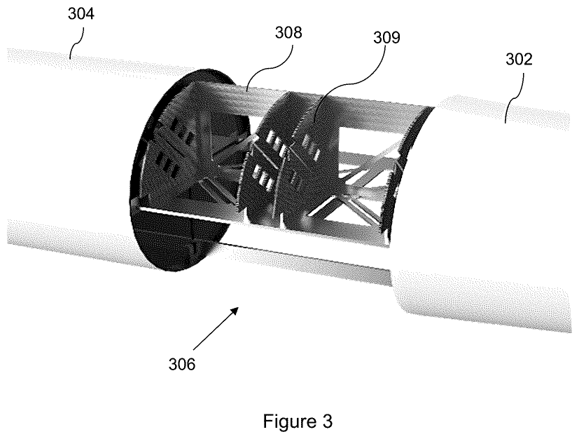

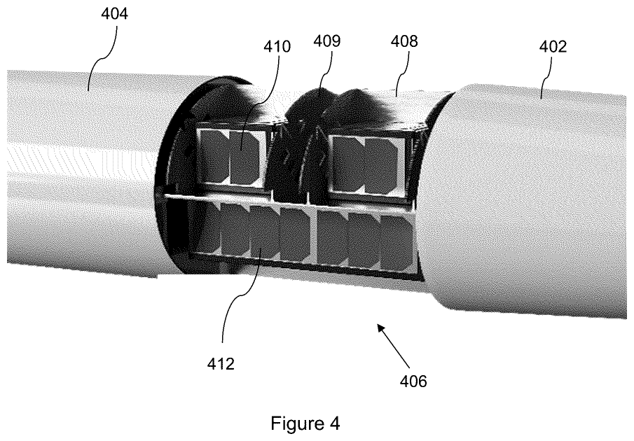

In this embodiment, an opening or aperture (106) can be opened or established by the linear and/or axial movement or extension or extrusion of the nose section away from the body section. As can be seen, the now-separated sections are joined by an intermediary structure (108) of the vehicle. This intermediary structure in this embodiment provides a combination of functions: securing the two sections together in (or during) the extended (or extending) configuration; providing at least part of the drive system or means for driving the axial extension movement; and housing or securing the payload(s) (110). FIGS. 3 and 4 illustrate features of this intermediary structure and secured payloads, according to embodiments of the invention, in more detail.

In these embodiments, the body section (104) of the vehicle comprises an actuator (105) for opening the aperture in the housing. The actuator co-operates with a rail (107) which is part of the intermediary structure 108; for example, the actuator extends the rail through the actuator mechanism, so that the rail extends out of (and later into) the body section (104), thereby moving the nose section (102). Here the actuator is a linear actuator, thus able to extend the nose section (102) in a linear direction; here, the extension is in the axial direction of the vehicle. The vehicle in this case being generally elongated and aerodynamically shaped for efficient flight during launch, having body and nose cone sections, the axial direction is also in the general (at least initial) direction of flight of the vehicle.

It is notable that in embodiments of the invention, in opening the aperture (106) or in the open configuration, there is no movement or projection of any component outside the previous maximum diameter of the housing in a radial direction orthogonal to the axial or flight direction. In embodiments in which the vehicle is still moving relative to an atmosphere/atmospheric resistance the vehicle retains as much aerodynamic efficiency as possible, as no component is moved outside the hole already punched in the atmosphere by the vehicle.

As noted in FIG. 2c, in general steps of a method according to one embodiment of the invention include initiating (250) a flight of a (suborbital) vehicle, and operating (260) a payload exposure system during the flight to open an aperture in the housing, to allow exposure of the housed test payload to the in-flight environment. The test payload can then be retained in the housing, and the aperture closed (270).

As noted above, in embodiments, the aperture is opened by axial extension of a first section of the vehicle from a second. This axial extension of the nose section allows for a simple mechanism and drive system, for example a ball screw mechanism with linear guides, to open and close the aperture. The rail (107) in this case forms part of the linear guide driven by the ball screw mechanism. Other known linear actuator mechanism can be used. The intermediary structure (108) can incorporate guide rails and cooperating grooves in the payload structures (or vice versa) allowing the payload structures to be moved into and out of the body section by the drive system.

As shown, in embodiments the aperture is accessible and/or exitable (for any deploying payload) around the entire circumference of the vehicle. This is in contrast to previously considered systems in which deployment is only from a window or other aperture on one side of a vehicle; here maximum use of payload space is allowed, and deployment or retention at any point around the circumference of the aperture is possible.

In alternative embodiments, alternative mechanisms for opening and/or closing the aperture are employed; for example, the opening may be effected simply by a flap or door in the vehicle, which can be opened or closed, or by a deployable or removable section or part of the vehicle.

In the embodiment shown in FIG. 1, on retraction of the extended nose section, this section is brought back into contact with the body at the annular division point, and seating features around this annular section cooperate to secure the nose section in place. In an embodiment, a raised (in the axial direction) annular ridge around or near a circumference of the body section, at a diameter similar to that of the body section, on retraction of the nose section mates with a corresponding raised annular ridge on the nose section, the nose section ridge having a slightly smaller diameter in order to seat it in the corresponding ridge on the body section. Sealing and friction reducing elements (120) can be disposed on the outer (inner) faces of the ridges to aid seating and opening/closure. The annular section sealing element in this embodiment incorporates an o-ring, in order to seal the payload bay while closed. This can be advantageous both in preventing exposure to the environment when not desired during flight, but also for sealing the payload compartment in case of a water landing after re-entry.

In addition, locking features can be applied in the closed configuration, for example during launch and after re-closure, to secure the aperture shut. For instance, a clamping mechanism is deployable in order to allow opening and extension of the nose section, and is automatically actuated to secure the nose section on retraction.

It should be noted that in other embodiments alternative means can be provided for providing the opening or aperture in the spacecraft. For example, in one other embodiment, a more traditional clam-shell fairing may be provided, in which two half sections of a nose section may be opened away from each other, exposing an enclosed payload, and provided with drive means to return the clam-shell halves back towards each other to re-enclose the payload. In another embodiment, an outer housing is provided with an opening or aperture, and an inner housing is provided with a corresponding aperture, above a housed payload. In a closed configuration the apertures are disposed at separate positions circumferentially around the vehicle; for the open configuration, the inner housing can be rotated inside the outer housing, in order to align the two apertures. This arrangement provides the advantage that no moving parts are present on the circumference of the launch vehicle.

It should be noted that the embodiments pictured in FIGS. 1a to 2c and described herein may have the advantages over this and other alternative systems of providing a simple mechanism for providing an opening, with as few moving parts as possible. This prevents or minimises failure modes for the spacecraft, both in deployment, and in surviving launch and re-entry intact. For example, the annular nature of the opposing sections of the opening may be much more easily and reliably seated and sealed on the body on retraction of the extruded nose section, than similar closing or sealing sections in alternative systems. In addition, this arrangement has a more efficient and reliable aerodynamic profile than alternative aperture-opening systems.

One goal of embodiments of the invention is to create a payload bay which is capable of exposing a high proportion of the on-board payloads to the space environment, and then be configurable to either deploy the exposed payloads or re-integrate them into the launch vehicle fuselage for safe return and recovery.

Features of the payload structure are also able to reduce integration time, improve electric power and data storage capability and increase the available volume for a given payload mass. With regards to improving the packing efficiency, the payload section uses a more spatially efficient standardised payload format, in addition to more bespoke payload formats as may be required to suit specific user hardware requirements/characteristics.

Referring additionally to FIGS. 3 and 4, illustrating the intermediary payload securing structure (308, 408) in more detail, instead of traditional ‘U’ payload module units, features of embodiments of the invention use wedge-shaped ‘slices’ of hemispheres or quadrants, with modular payload supports (309, 409). This improves packing efficiency and available volume.

One feature of embodiments is that the payload structure is segmented through the centre of the module by modular supporting ‘panes’ (309, 409). These can for example accommodate up to four 10×10 mm Cubesat payloads across a cross section. Alternatively, one hemisphere can instead be comprised of a single pane, so that a payload with a 20 mm×10 mm cross section (such as a 6 U Cubesat) can be integrated. The panes are modular, and combine to give the structure internal rigidity by slotting into grooves on the ends of the payload area (306, 406). They are then supported by 3-4 guide rails at the cardinal points along the circumference of the payload module.

In this way, payloads (410) within the payload bay can be retained internally along the central surfaces of the payload integration structure. Note that payloads can also be retained axially on rolling surfaces, so that powered deployment can be integrated to each payload module. In the example shown in FIG. 4, a larger payload (412) is accommodated in one payload area, whereas in another payload area, additional modular payload support panes (309, 409) are included, providing retention capability for several smaller payloads (410).

As noted above, in some embodiments, the payload structure may be used to deploy payload items, in addition to testing items during flight (and/or in addition to retaining and returning some of the payload items or components on any given flight). Thus in one alternative embodiment, actuation or deployment of payloads once the payload bay is exposed can be achieved using the centripetal force of the spinning launch vehicle. In an embodiment, a deployment device such as a roller is biased to prevent movement of the payload in an inward radial direction (towards the centre of the vehicle, the radial direction being orthogonal to the axial/flight direction) and to permit (rather than drive) movement of the payload in an outward radial direction. The deployment device or rollers in this instance act as passive guides allowing the outward movement. In this embodiment, in the closed or stowed configuration, while the vehicle rotates during launch or flight, the payload items are retained by the inner surface of the housing of the body of the vehicle, rather than being fixed or secured onto the payload structure.

Therefore once the extrusion of the nose section exposes the payload structure as usual, these payload items are no longer secured, and the rotational motion of the vehicle combined with (now) the lack of centripetal force exerted by the inner housing of the body, permits egress of these payload items, along the deployment device or rollers/guides, so that they move away from the payload structure and thus are deployed from the vehicle.

In embodiments, rails of the extrusion structure also serve as electrical conduits, so that an electrical power source and wired data transmission lines can be transferred to all four quadrants. The lower (and possibly upper) rail can be used to actuate the payload along the axis of the launch vehicle, using a common linear actuation method such as rack and pinion, hydraulics or a spring loaded system which enables the bay to fail shut. A locking mechanism can be used to retain the payload bay inside the launch vehicle airframe during the launch and recovery phases of flight. It should also be noted that, during flight, the structural rigidity, aerothermal protection and strength in compression are primarily handled by the external tube of the launch vehicle.

The grooves cut into the ends of the pane units are present to allocate rollers, which can then be actuated electrically to deploy the payload for a deployment mission once it is exposed to the space environment. Alternatively, the grooves can accommodate clasps, which can then retain the payload for an exposure-and-return mission or in embodiments as noted above release them at apogee using the centripetal force of a spinning launch vehicle for a deployment mission. The central slit between these grooves houses a guide flange attached to the payload, ensuring that the payload deploys on a 45 degree angle and thus avoids the obstruction of the payload guide rails.

In more typical embodiments in which the payload items are for testing without deployment, i.e. purely in microgravity or through an exposure-and-return mission, in embodiments they can make use of a greater proportion of the payload area by using a ‘slice’ payload unit. A slice unit affords a greater volume of payload for the same packing volume within the launch vehicle, by as much as 30%. Although the slice format may integrate into the payload pane prior to sliding the pane into the bay itself, it will still be accessible during later stages of the launch sequence (up to the point of payload stowaway and locking).

In embodiments of the invention, in contrast with previously considered systems, power can be provided by the vehicle to the payloads, rather than each payload requiring its own power source. In embodiments, power is shared between payloads through the modular housings, which for example connect structurally and electronically as standard. In embodiments, the vehicle comprises a data acquisition system. This can be provided as an on-board feature of the vehicle, rather than requiring the payload items to provide this. Power and data acquisition components of the vehicle can be accommodated in a separated/sealed section of the body, for example below the section of the body which accommodates the extendable payload structure.

Mission profiles for testing and possible deployment, for a variety of different payloads, will of course vary. As an example, a payload bay might be taken up by eight payload customers, two of whom are wishing to deploy their Cubesat payload, two of whom wish to expose their payload to the space environment, and four of whom have bespoke payloads in a ‘slice’ format, and simply require access to microgravity conditions. The latter customer may in addition seek to minimise the amount of environmental exposure that their payloads are subjected to. Given the modularity available from the internally retained, axially extruded payload design approach, embodiments of the invention can accommodate all of these customers.

In an example, the intermediate structure and/or payload exposure system comprises a first housing portion and a second housing portion. The first housing portion may be used to house a first payload type, and the second housing a second type. On opening the aperture, the first housing portion is retained with the body of the vehicle, so that only the second portion is exposed to the environment. In this embodiment, the intermediate structure comprises a subdivision, separating the first and second portions; this subdivision can comprise a sealing element in order to further reduce exposure of the first housing portion to the environment.

Integration of the payloads to the airframe during the pre-launch sequence can be simple and easy due to the 360 degree access afforded by the linear housing extension feature. In embodiments, the actuation along the axis to expose the payload structure can be limited to only part actuation or extension, so that the second/upper portion of the payload bay is exposed to the space environment, ensuring that the lower section is kept within the vehicle airframe. In an alternative embodiment mission, two cubes at payloads can be deployed whilst retaining the payloads of the customers that wished to undertake an exposure-and-return mission. The drive mechanism can then be actuated to return back to the closed position and re-seal the payload bay prior to re-entry to the atmosphere.

Note that in sub-orbital embodiments, given the trajectory and altitude of the parabolic arc of a suborbital rocket, the data collection point takes place in an environment with no air resistance and at relatively low velocities (thus lower inertial forces) compared to the rest of the flight environment. As such, provided that a suitable locking mechanism is used which protects the actuation system from loading and vibrations prior to apogee, the actuation mechanism can operate during the data collection phase of a mission, and need only operate within this environment.

It will be appreciated by those skilled in the art that the invention has been described by way of example only, and that a variety of alternative approaches may be adopted without departing from the scope of the invention.

1. A suborbital vehicle assembly for payload testing, comprising:
a housing for accommodating a test payload therein; and
a payload exposure system coupled to the housing, operable to: during flight, open an aperture in the housing to allow exposure of a housed test payload to an in-flight environment;
and close the aperture.

2. An assembly according to claim 1, wherein the payload exposure system comprises an actuator for opening and closing the aperture.

3. An assembly according to claim 2, wherein the actuator is a linear actuator, and wherein the linear actuator is operable in an axial direction of the vehicle assembly.

4. An assembly according to claim 1, comprising a first vehicle section and a second vehicle section, wherein the payload exposure system comprises an intermediary structure coupled between the first and second sections.

5. An assembly according to claim 4, wherein: in a closed configuration the first and second vehicle sections are coupled together; and wherein the payload exposure system is operable in the closed configuration to separate the first and second vehicle sections to establish the aperture between the first and second vehicle sections in an open configuration.

6. An assembly according to claim 5, wherein the payload exposure system is operable to return the first and second vehicle sections from the open configuration to the closed configuration.

7. An assembly according to claim 4, comprising one or more sealing elements between the first and second vehicle sections.

8. An assembly according to claim 4, wherein the intermediary structure comprises a modular payload support.

9. An assembly according to claim 1, wherein the payload exposure system is operable to, during a rotational manoeuvre of the vehicle, permit egress of a housed payload via the aperture, for deployment.

10. A spacecraft vehicle assembly, comprising:
a housing for accommodating a payload therein, the housing comprising a body and a fairing, the body and fairing being separably coupled to one another; and
an actuatable system for axially extending the fairing away from the body to establish an opening between the fairing and the body,
the actuatable system comprising means for removably securing one or more payload items.

12. An assembly according to claim 11, wherein the system is operable to retract the fairing back to the body to close the opening.

13. A spacecraft vehicle assembly, comprising:
a housing for accommodating a payload therein; and
a payload deployment system coupled to the housing, operable to: open an aperture in the housing; and, during a rotational manoeuvre of the vehicle, permit egress of a housed payload via the aperture for deployment.

14. A method for testing payload of a suborbital vehicle, comprising:
operating a payload exposure system of a suborbital vehicle during a flight of the vehicle to:
open an aperture in a housing of the vehicle, to allow exposure of a housed test payload to an in-flight environment; and
close the aperture.
